(19) United States
(12) Patent Application Publication
(10) Pub. No.: US 2010/0084939 A1
(43) Pub. Date: Apr. 8, 2010

(54) ELECTRIC MOTOR APPARATUS

(76) Inventors: Hiroto Isoda, Fujiyoshida-shi (JP); Yuji Akao, Tokyo (JP); Yasuki Kuwabara, Fujiyoshida-shi (JP); Masahiro Furuya, Yamanashi-ken (JP); Masayuki Hada, Fujiyoshida-shi (JP)

Correspondence Address: WENDEROTH, LIND & PONACK, L.L.P., 1030 15th Street, N.W.,, Suite 400 East, Washington, DC, 20005-1503, US

(21) Appl. No.: 12/564,490

(22) Filed: Sep. 22, 2009

(30) Foreign Application Priority Data
Sep. 22, 2008 (JP) 2008-243243

(51) Int. Cl. H02K 21/14

(52) U.S. Cl. 310/179

(57) ABSTRACT

An electric motor apparatus providing increased output torque and allowing rotation in a predetermined direction includes a rotor 135 having a permanent magnet having two magnetic poles spaced from each other by approximately 180 degrees about a rotation axis, a stator having a substantially (T-shape (Y-shape) as a whole and having first, second and third magnetic pole portions 112, 114 and 116 disposed around the rotor and connecting portions 122, 124 and 126, which are narrow in their middle regions and each connects between an associated pair of adjacent magnetic pole portions, a first electromagnetic coil 140 inducing a magnetic circuit that passes through the first and second magnetic pole portions, and a second electromagnetic coil 142 inducing a magnetic circuit that passes through the second and third magnetic pole portions. The first and second electromagnetic coils are set parallel to and at opposite sides of the second magnetic pole portion 112. The first electromagnetic coil has one and other ends magnetically coupled to the first and second magnetic pole portions, respectively. The second electromagnetic coil has one and other ends magnetically coupled to the third and second magnetic pole portions, respectively. The first and second electromagnetic coils are selectively excited to control the rotation of the rotor.

This application claims priority under 35 U.S.C. §119 to Japanese Patent application No. JP2008-243243 filed on Sep. 22, 2008, the entire contents of which are hereby incorporated by reference.

### FIELD OF THE INVENTION

The present invention relates to an electric motor apparatus for use, for example, in small electronic devices such as mobile phones and digital cameras.

### BACKGROUND OF THE INVENTION

There are small electronic devices, such as mobile phones, having a camera function, for example. Such small electronic devices use an electric motor apparatus having an electric motor to drive a lens system.

Japanese Patent Application Publication No. 2004-364490 discloses such an electric motor apparatus suitable for use in small electronic devices or the like. The electric motor of this apparatus, however, has a structure comprising a rotor having a permanent magnet with two magnetic poles and an electromagnet with two magnetic poles disposed around the rotor. This motor structure has likelihood that the rotor may fail to rotate in a predetermined direction when started, or that even if the rotor rotates in a predetermined direction, the rotor may start to rotate in a reversed direction when an impact is applied to the apparatus.

Japanese Patent No. 279,666 also discloses an electric motor apparatus suitable for use in small electronic devices or the like. The electric motor of this apparatus has a structure comprising a rotor having a permanent magnet with four magnetic poles and an electromagnet with two magnetic poles disposed around the rotor. This electric motor apparatus can fix the rotational direction of the rotor. However, because the rotor needs four magnetic poles to be magnetized, the magnetic efficiency is degraded, and hence large output torque cannot be obtained.

### SUMMARY OF THE INVENTION

The present invention has been made in view of the above-described circumstances. Accordingly, an object of the present invention is to provide an electric motor apparatus using a rotor having a permanent magnet with two magnetic poles and yet capable of controlling the rotational direction of the rotor to a desired direction.

The present invention provides an electric motor apparatus including a rotor having a rotation axis, a permanent magnet having two magnetic poles spaced from each other by approximately 180 degrees about the rotation axis, and a stator having first to third magnetic pole portions successively disposed around the rotor, the first to third magnetic pole portions being spaced from each other in a circumferential direction about the rotation axis, and respectively having magnetic pole surfaces disposed to face the rotor. The stator further has connecting portions each connecting between an associated pair of adjacent ones of the first to third magnetic pole portions around the rotor. The second magnetic pole portion extends radially outward with respect to the rotation axis from the magnetic pole surface of the second magnetic pole portion. The first and third magnetic pole portions extend radially outward with respect to the rotation axis and away from each other from their respective magnetic pole surfaces. The connecting portions each have a reduced cross-sectional area that is gradually reduced from the associated pair of adjacent magnetic pole portions toward a substantially central region between the associated pair of adjacent magnetic pole portions and each have a smallest cross-sectional area at the substantially central region between the associated pair of adjacent magnetic pole portions. The electric motor apparatus further includes a first electromagnetic coil and a second electromagnetic coil. The first electromagnetic coil induces a magnetic circuit that passes through the first and second magnetic pole portions. The second electromagnetic coil induces a magnetic circuit that passes through the second and third magnetic pole portions. The first and second electromagnetic coils are set parallel to and at opposite sides of the second magnetic pole portion. The first electromagnetic coil has one end magnetically coupled to the first magnetic pole portion, and an other end magnetically coupled to the second magnetic pole portion. The second electromagnetic coil has one end magnetically coupled to the third magnetic pole portion, and an other end magnetically coupled to the second magnetic pole portion. The first and second electromagnetic coils are selectively excited to control the rotation of the rotor.

In this electric motor apparatus, the rotor has two magnetic poles. Thus, it is possible to obtain increased output torque as compared to an electric motor apparatus whose rotor has four magnetic poles as disclosed in the aforementioned Japanese Patent No. 279,666. Meanwhile, the stator has three magnetic poles. Therefore, the rotor can be rotated in a desired direction by controlling the application of an electric current to the electromagnetic coils. In addition, since the connecting portions between the first to third magnetic pole portions are shaped narrow in their middle regions, and the magnetic reluctance of the connecting portions is increased, and thus, the mutually adjacent magnetic pole portions are magnetically isolated from each other.

The electric motor apparatus may be arranged as follows. The stator has a pass-through hole for coaxially accommodating the rotor, and the pass-through hole is defined by the magnetic pole surfaces of the first to third magnetic pole portions and respective inner surfaces of the connecting portions. The connecting portions extending between the first and second pole portions and between the second and third magnetic pole portions, and the stator has notches formed at the pass-through hole, at positions adjacent to the magnetic pole surfaces of the first and third magnetic pole portions. The notches extend substantially parallel to the rotation axis. With this structure, when the electromagnetic coils are deenergized, the rotor can be held in a stable position since the magnetic flux from the permanent magnet of the rotor passes more through the magnetic pole surface that one of the magnetic poles of the rotor faces adjacently.

The electric motor apparatus may further include a notch that extends substantially parallel to the rotation axis and is formed in the magnetic pole surface of the second magnetic pole portion. That is, the magnetic pole surface of the second magnetic pole portion is divided in the circumferential direction into two areas at the left and right sides of the notch. With this structure, when the rotor is stopped, one of the two magnetic poles of the rotor adjacently faces the left or right portion of the magnetic pole surface of the second magnetic pole portion, and when the electromagnetic coils are deenergized, the magnetic flux from the permanent magnet of the rotor passes more through the portion of the magnetic pole surface that the magnetic pole adjacently faces. Thus, the rotor can be held stably when the electromagnetic coils are deenergized.

Further, the electric motor apparatus may further include two notches that extend parallel to the rotation axis and may be formed at spaced positions in the magnetic pole surface of the second magnetic pole portion, the two notches spaced from each other with a substantially central region of the magnetic pole surface being interposed between the two notches.

The electric motor apparatus may be arranged as follows. The stator is a member that is thin and flat in the direction of the rotation axis, and the apparatus further includes a thin and flat first and second frame member that hold the stator between the frames from both sides in the direction of the rotation axis. The first frame member has a pass-through hole aligned with the pass-through hole of the stator in the direction of the rotation axis and a rotor support member fitted in the pass-through hole. The rotor is rotatably supported by the rotor support member.

By providing the rotor support member as a distinct member separated from the frame member, the rotor support member can be formed by precision molding. Thus, the rotor can be positioned accurately.

The stator and the permanent magnet of the rotor may be formed to have substantially the same thickness in the direction of the rotation axis. The purpose of this is to improve the magnetic efficiency between the stator and the rotor.

The electric motor apparatus may further include a speed reduction gear that outputs the rotation of the rotor to the outside of the electric motor apparatus after reducing the speed of the rotation. The speed reduction gear may have an output gear shaft and an intermediate gear shaft that transmits the rotation of the rotor to the output gear shaft. The second magnetic pole portion may have pass-through holes through which the output gear shaft and the intermediate gear shaft are inserted, respectively. The purpose of this arrangement is to install the speed reduction gear intensively at the second magnetic pole portion and to thereby reduce the overall size of the apparatus.

The arrangement may be as follows. The stator has extensions that extend in mutually opposite lateral directions from an extended end portion that is extended radially outwardly from the magnetic pole surface of the second magnetic pole portion. Thus, the stator has a substantially H-shape as a whole. The first and second electromagnetic coils each comprising a flat plate-shaped magnetic member and a coil wire wound around the magnetic member, the flat plate-shaped magnetic members of the first and second electromagnetic coils having one end portions engaged and connected to the first and third magnetic pole portions, respectively, and other end portions engaged and connected to the corresponding extensions of the third magnetic pole portion, respectively.

With the above-described shape of the stator and the configuration of the electromagnetic coils, the electric motor apparatus can be reduced in size.

The arrangement may also be as follows. The stator has extensions extending in mutually opposite lateral directions from an extended end portion of the second magnetic pole portion, the extended end portion that is extended radially outwardly from the magnetic pole surface. Thus, the stator has a substantially H-shape as a whole. The first and second electromagnetic coils each comprise a flat plate-shaped magnetic member and a coil wire wound around the magnetic member. The magnetic members of the first and second electromagnetic coils have one-end portions that are engaged and connected to the first and third magnetic pole portions, respectively, and other end portions are connected to respective end portions of the corresponding extensions of the third magnetic pole portion. The first and second frame members are stacked to hold the stator and the first and second electromagnetic coils between the frame members from both sides in the direction of the rotation axis. The stacked first and second frame members, the stator and the magnetic members of the first and second electromagnetic coils have pass-through holes in their portions superimposed in the direction of the rotation axis, the pass-through holes being aligned with each other in the direction of the rotation axis. Fastening screws are passed through the pass-through holes to secure the first and second frame members, the stator and the first and second electromagnetic coils to each other.

The present invention will be explained below by way of embodiments shown in the accompanying drawings.

### BRIEF DESCRIPTION OF THE DRAWINGS

FIG. 1 is a perspective view of an electric motor apparatus according to a first embodiment of the present invention.

FIG. 2 is an exploded view of the electric motor apparatus shown in FIG. 1.

FIG. 3 is a plan view showing the arrangement of a rotor and a stator in the electric motor apparatus shown in FIG. 1, of which: part (a) shows an example in which the stator is provided with two notches; part (b) shows an example in which the stator is provided with four notches; and part (c) shows an example in which the stator is provided with three notches.

FIG. 4 is a vertical sectional view of the electric motor apparatus in FIG. 1, showing the way in which a speed reduction gear is installed.

FIG. 5 is a perspective view showing an example in which covers are attached to cover the electromagnetic coils of the electric motor apparatus in FIG. 1.

FIG. 6 is a perspective view of an electric motor apparatus according to a second embodiment of the present invention that is arranged to deliver a reciprocating motion.

FIG. 7 is a perspective view of a mirror-driving unit using the electric motor apparatus shown in FIG. 1.

FIG. 8 is an explanatory view showing the control of the application of an electric current to the electromagnetic coils to rotationally drive the rotor of the electric motor apparatus shown in FIG. 1.

FIG. 9 is a perspective view showing an example of the installation of an output gear and shaft member of an output gear shaft (output gear-carrying shaft) used in the electric motor apparatus according to the present invention.

FIG. 10 is a diagram for explaining the leakage of a lubricant that might occur in the electric motor apparatus shown in FIG. 1 if fastening screws were designed not to project from frame members.

### DETAILED DESCRIPTION OF THE INVENTION

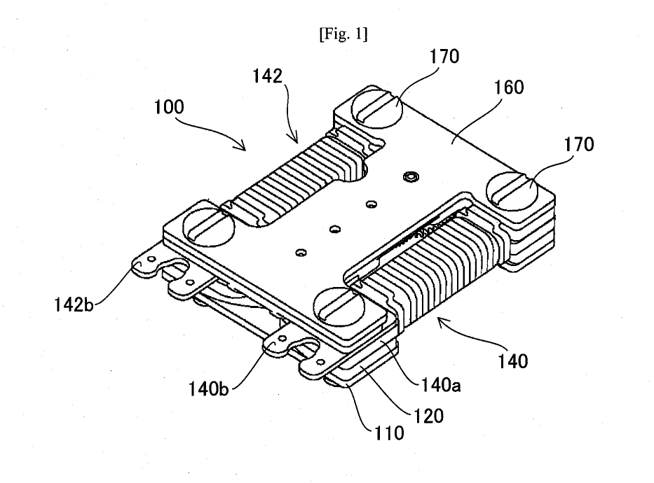

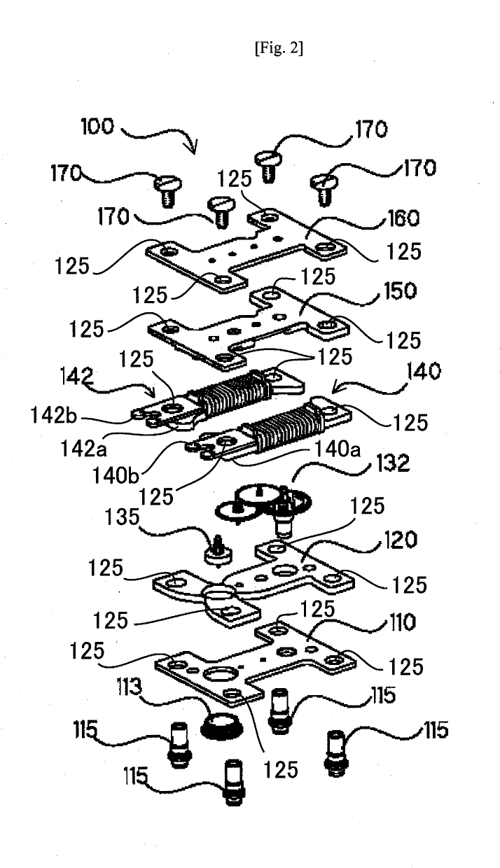

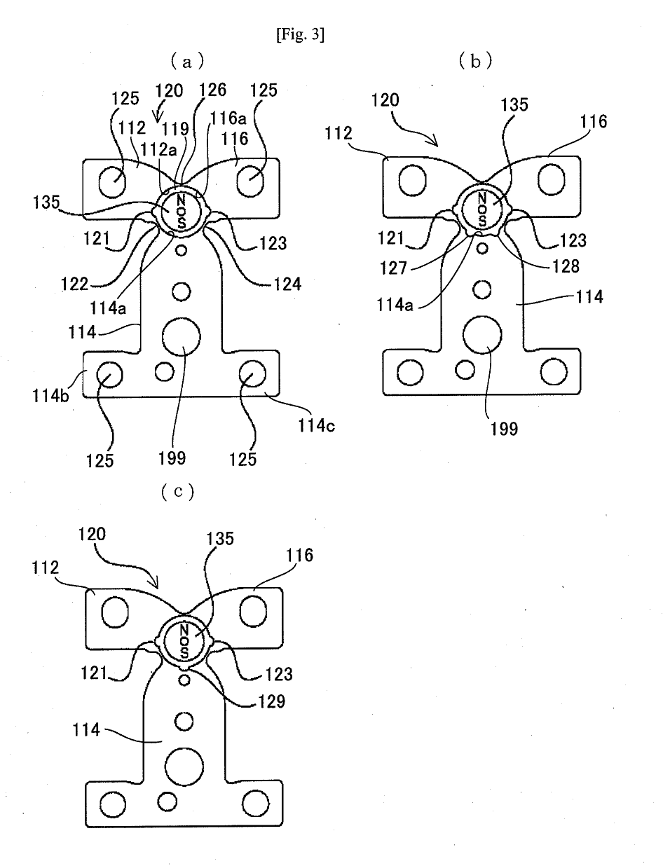

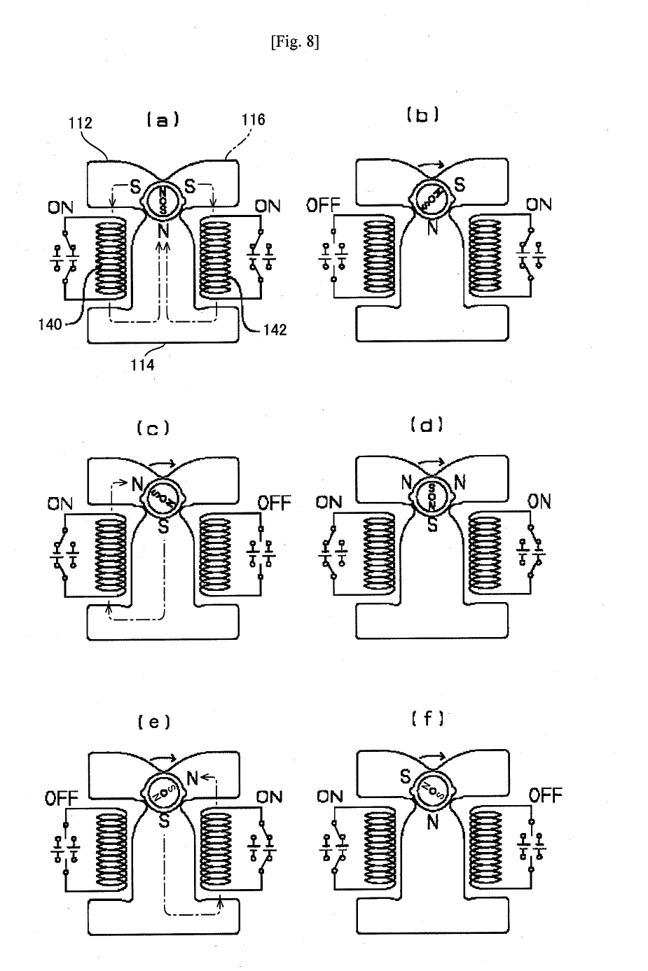

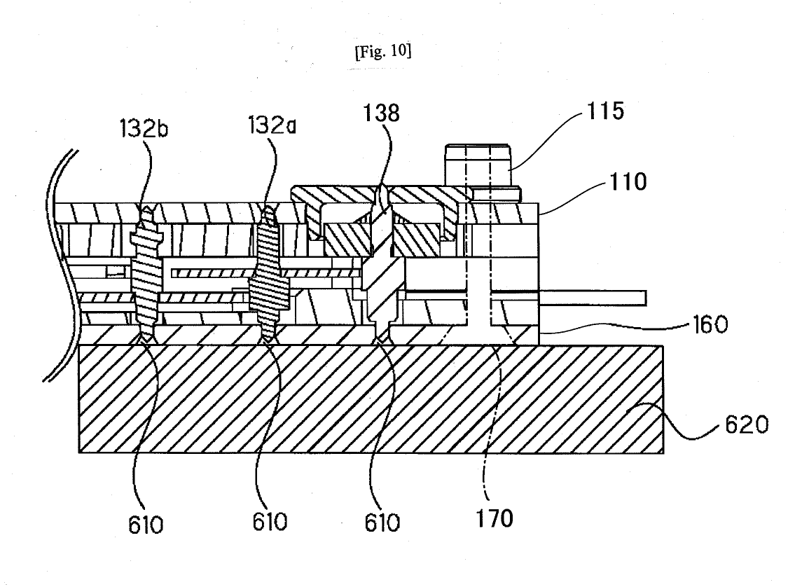

FIGS. 1 to 4 show an electric motor apparatus 100 according to a first embodiment of the present invention. The electric motor apparatus 100 has a stator 120, a rotor 135, a first electromagnetic coil 140 and a second electromagnetic coil 142 as main constituent elements, which are arranged in positional relationship as shown in FIGS. 3 and 8, and further has an upper frame member 160, a lower frame member 110 and an insulating spacer 150 as shown in FIG. 2, which are used to assemble and retain the main constituent elements. These constituent elements are stacked up vertically in mutual relationship as shown in FIG. 2, and fastening screws 170 are inserted from above into holes 125 formed in the constituent elements. The holes 125 are vertically aligned with each other when the constituent elements are stacked up as stated above. The fastening screws 170 are engaged with internally threaded holes of studs 115 that are inserted into the holes 125 from below. Thus, the constituent elements are assembled into the electric motor apparatus 100. In FIG. 2, reference numeral 132 denotes a speed reduction gear for transmitting the rotational torque of the rotor 135 to the outside after increasing the rotational torque. It should be noted that both the fastening screws 170 and the studs 115 are designed to project from the frame members 110 and 160, for the reasons described as follows. In the assembly of the electric motor apparatus 100, the constituent elements may be placed on a jig 620 as shown in FIG. 10. In such a case, if the fastening screws 170 are designed not to project from the frame member 160 as shown in FIG. 10, the whole surface of the frame member 160 is in contact with the upper surface of the jig 620. Consequently, the lubricant filled in holes 610 of the frame member 160 that support the ends of gear shafts 132a, 132b and 138 of the speed reduction gear may leak out to the upper surface of the jig 620. To prevent the leakage of the lubricant, the fastening screws 170 and the studs 115 are designed to project from the frame members 110 and 160.

The rotor 135 is in the shape of a thin disk and made of a permanent magnet having two magnetic poles N and S magnetized at respective positions spaced from each other by approximately 180 degrees about its center axis, i.e. rotation axis.

The stator 120 has a pass-through hole 119 that accommodates the rotor 135. The stator 120 has a first magnetic pole portion 112, a second magnetic pole portion 114 and a third magnetic pole portion 116 circumferentially spaced from each other around the pass-through hole 119 and further has connecting portions 122, 124 and 126 that connect between the mutually adjacent magnetic pole portions, respectively. The radially inner surfaces of the first, second and third magnetic pole portions 112, 114 and 116 define magnetic pole surfaces 112a, 114a and 116a, respectively, and the magnetic pole surfaces constitute the wall surface of the pass-through hole 119 in cooperation with the inner surfaces of the connecting portions 122, 124 and 126. The second magnetic pole portion 114 extends radially outward with respect to the rotation axis. The first and third magnetic pole portions 112 and 116 extend radially outward with respect to the rotation axis and away from each other. The connecting portions 122, 124 and 126 each have a reduced cross-sectional area that is gradually reduced from an associated pair of magnetic pole portions that are mutually adjacent to each other toward a substantially central region between the associated pair of the magnetic pole portions and each have the smallest cross-sectional area at the substantially central region between the associated pair of adjacent magnetic pole portions. The first to third magnetic pole portions 112, 114 and 116 assume, in combination, a substantially T-shape (substantially Y-shape). In the illustrated example, however, the second magnetic pole portion 114 has extensions 114b and 114c extending in mutually opposite lateral directions from the extended end portion of the second magnetic pole portion, the end portion remote from the rotor 135. Thus, the stator 120 has a substantially H-shape as a whole.

The first electromagnetic coil 140 and the second electromagnetic coil 142 are formed by winding a copper wire around thin plate-shaped magnetic members 140a and 142a made, for example, of a high-permeability alloy of iron and nickel. The first and second electromagnetic coils 140 and 142 are disposed parallel to and at the opposite sides of the second magnetic pole portion 114. The opposite ends of the magnetic member 140a of the first electromagnetic coil 140 are connected to the first magnetic pole portion 112 and the extension 114b (of the second magnetic pole portion 114) by fastening screws 170 through the respective pass-through holes 125. The opposite ends of the magnetic member 142a of the second electromagnetic coil 142 are engaged and connected to the third magnetic pole portion 116 and the extension 114c (of the second magnetic pole portion 114) by fastening screws 170 through the respective pass-through holes 125. When the first electromagnetic coil 140 is excited, the resulting electromagnetic flux passes through a magnetic circuit formed by the first magnetic pole portion 112, the rotor 135, the second magnetic pole portion 114 and the first electromagnetic coil 140. Whether the electromagnetic flux passes through the magnetic circuit clockwise or counterclockwise is determined by the direction of current application to the electromagnetic coil, as will be described later by using FIG. 8. When the second electromagnetic coil 142 is excited, the resulting electromagnetic flux passes through a magnetic circuit formed by the third magnetic pole portion 116, the rotor 135, the second magnetic pole portion 114 and the second electromagnetic coil 142. In the illustrated example, the magnetic member 140a has a terminal member 140b secured to one end of the magnetic member. Similarly, the magnetic member 142a has a terminal member 142b secured to one end of the magnetic member. Further, the electric motor apparatus of this embodiment has a first frame member, i.e. upper frame member 160, and a second frame member, i.e. lower frame member 110. The first and second frame members are stacked to hold the stator and the first and second electromagnetic coils between the frames from both sides in the direction of the rotation axis. The stacked first and second frame members, the stator and the magnetic members of the first and second electromagnetic coils have pass-through holes 125 in the portions superimposed in the extending direction of the rotation axis. The pass-through holes 125 are aligned with each other in the extending direction of the rotation axis. The first and second frame members, the stator and the first and second electromagnetic coils are connected and secured together by four fastening screws 170 passed through the pass-through holes 125.

Because the connecting portions 122, 124 and 126 are shaped narrow in their middle regions as stated above, the magnetic reluctances between the magnetic pole surfaces 112a, 114a and 116a increase. Consequently, the magnetic flux concentrates on each of the magnetic pole surfaces 112a, 114a and 116a, the magnetic interaction between the magnetic pole surfaces 112a, 114a and 116a and the magnetic poles of the rotor 135 is intensified, and thus, the torque applied to the rotor 135 is increased. It should be noted that the electromagnetic flux should be substantially prevented from passing through the connecting portions 122, 124 and 126. For this purpose, a low-permeability material such as stainless steel may be welded to portions between the magnetic pole portions to form the connecting portions 122, 124 and 126. It is also possible to provide a space between each pair of adjacent magnetic pole portions. As shown in part (a) of FIG. 3, the wall surface that defines the pass-through hole 119 for accommodating the rotor 135 is formed with two notches 121 and 123 extending parallel to the rotation axis of the rotor 135.

Part (b) of FIG. 3 shows a modification of the embodiment of the notches shown in part (a) of FIG. 3, in which notches 127 and 128 are provided at spaced positions in the magnetic pole surface of the second magnetic pole portion 114, spaced from each other with a substantially central region of the magnetic pole surface being interposed between the notches. The notches 127 and 128 are provided to extend parallel to the rotation axis of the rotor 120.

Part (c) of FIG. 3 shows another modification of the embodiment shown in part (a) of FIG. 3, in which a notch 129 is provided at the center position of the magnetic pole surface 114a of the second magnetic pole portion 114. These notches work as follows. When the electromagnetic coil that has been energized is deenergized in the state shown in any of parts (b), (c), (e) and (f) of FIG. 8 (described later), the magnetic flux passing through the magnetic poles of the rotor 135 passes more through the adjacent magnetic pole surface portion at the right or left side of the notch 129, depending on the inclination of the rotor 135. Thus, the rotor 135 is held even more stably at the relevant position.

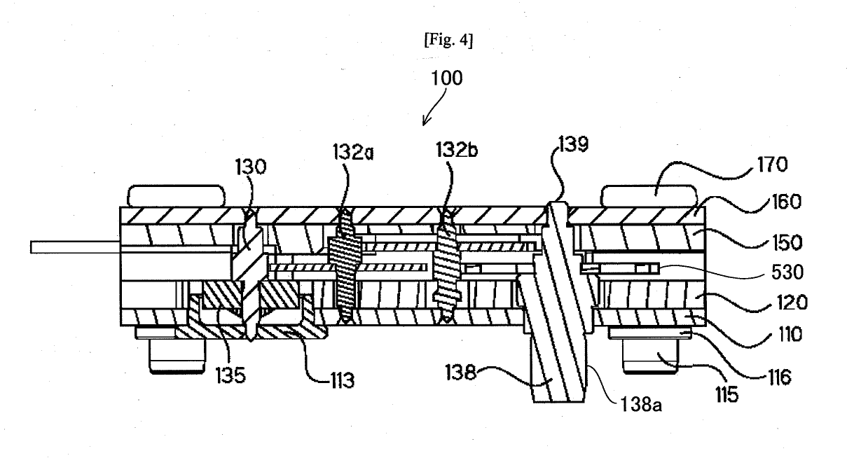

FIG. 4 is a vertical sectional view of the electric motor apparatus 100, showing the way in which the speed reduction gear 132 is installed. The speed reduction gear 132 has a pinion shaft (pinion-carrying shaft) 130 secured to the rotor 135 coaxially with the rotor, intermediate gear shafts (intermediate gear-carrying shafts) 132a and 132b, and an output gear shaft (output gear-carrying shaft) 138. The rotation of the rotor 135 is reduced in speed by being transmitted successively through the intermediate gear shafts 132a and 132b to the output gear shaft 138, and the rotational torque of the rotor 135 increased through the speed reduction is output from the output gear shaft 138. The rotor 135 has the same thickness as that of the stator 120 and is rotatably supported at the same level as the stator 120 by a rotor cup 113, serving as a rotor support member, which is press-fit into a hole formed in the lower frame member 110. The rotor cup 113 can be precision-machined. Therefore, the rotor 135 supported by the rotor cup 113 can be accurately set concentrically in the pass-through hole 119 of the stator 120. The upper end 139 of the output gear shaft 138 as seen in FIG. 4 projects upward from the upper frame member 160. The reason for this is as follows. When another gear or the like is fitted to the output end (lower end) of the output gear shaft 138, a jig may be applied to the projecting upper end 139 to support the projecting upper end, and thus, unnecessary force is prevented from being applied to the upper frame member 160.

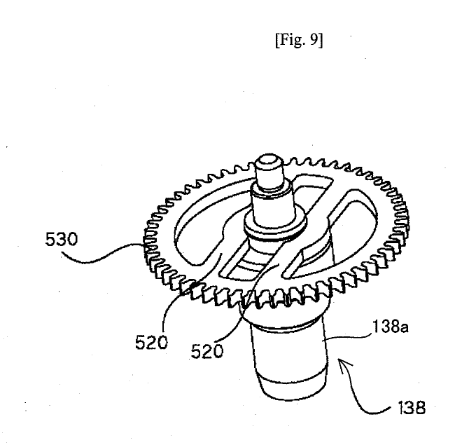

FIG. 9 shows one example of the way in which an output gear 530 and shaft member 138a of the output gear shaft 138 are connected to each other. That is, the output gear 530 has two parallel connecting bars 520 extending in the diametrical direction. The shaft member 138a that is clamped between the connecting bars 520 is secured. When an excessive load is applied to the shaft member 138a, sliding occurs between the shaft member 138a and the connecting bars 520 to prevent the output gear 530 from being excessively loaded.

In the electric motor apparatus 100 according to the present invention, necessary magnetic poles are induced in the three magnetic pole portions 112, 114 and 116 around the rotor 135 by properly controlling the supply (application) of an electric current to the electromagnetic coils 140 and 142, and thus, the rotor 135, which comprises a permanent magnet with two magnetic poles, rotates in a desired direction. FIG. 8 shows an example of such control of the electromagnetic coils. That is, the figure shows an example in which the rotor is rotated clockwise by controlling the supply of electric current to the electromagnetic coils in a sequence as shown in parts (a) to (f) of FIG. 8. For example, when the two electromagnetic coils 140 and 142 are brought into an energized state as shown in part (a) of FIG. 8 from a state where the supply of electric current to the electromagnetic coils 140 and 142 is OFF (non-energized state), magnetic poles are induced in the first to third magnetic pole portions 112, 114 and 116 around the rotor 135 as shown in the figure. Consequently, the rotational position of the rotor 135 is as shown in the figure. The rotor 135 assumes the position shown in part (a) of FIG. 8 independently of the angle position that the rotor 135 assumed in the non-energized state. Accordingly, if the magnetic poles induced in the magnetic pole portions 112, 114 and 116 are controlled as shown in parts (b) to (f) of FIG. 8, the rotor 135 is surely rotated clockwise. It will be understood that even if the first energized state established after the non-energized state is any other than the state shown in part (a) of FIG. 8, the rotor 135 is surely rotated clockwise in the same way as the above. It should be noted that the stepping motor has the characteristics that the rotor remains in the rotational position assumed at the time the electromagnetic coils are deenergized. Therefore, the first rotational direction of the rotor 135 when it is started to rotate can be specified by bringing the electromagnetic coils into an energized state from the non-energized state, taking into account the energized state of the electromagnetic coils immediately before the non-energized state.

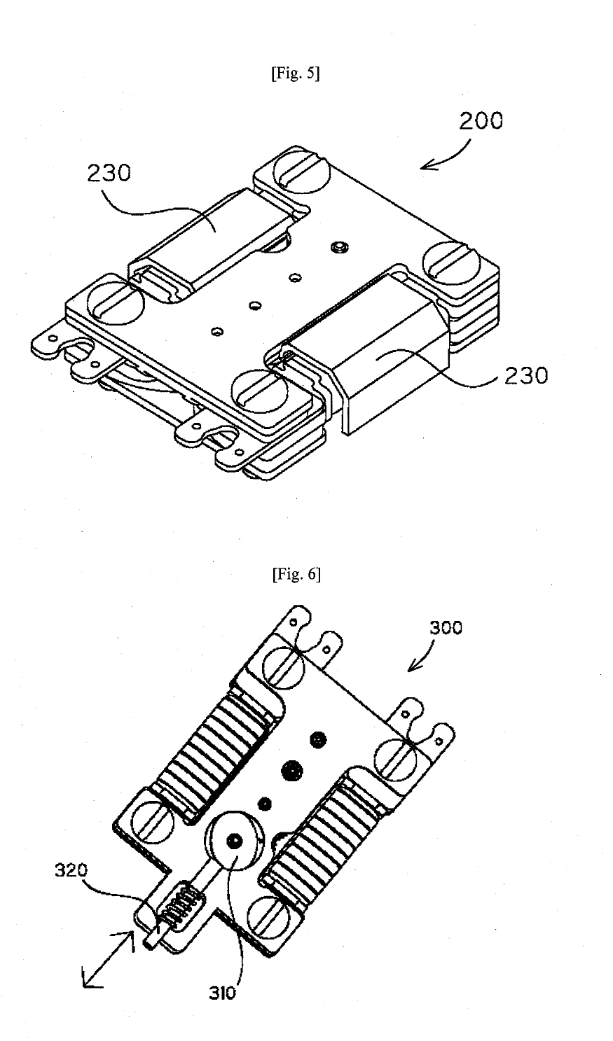

FIG. 5 shows the above-described electric motor apparatus with protection covers 230 fitted around the electromagnetic coils, respectively.

FIG. 6 shows an electric motor apparatus 300 according to a second embodiment of the present invention. The apparatus 300 has substantially the same structure as that of the above-described electric motor apparatus 100. In the electric motor apparatus 300, an elliptic output member 310 is coaxially fitted to the rotor, and an output pin 320 is spring-urged to set one end to abut against the peripheral surface of the elliptic output member 310. Thus, the output pin 320 reciprocates in the axial direction of the pin in response to the rotation of the elliptic output member 310 caused by the rotation of the rotor.

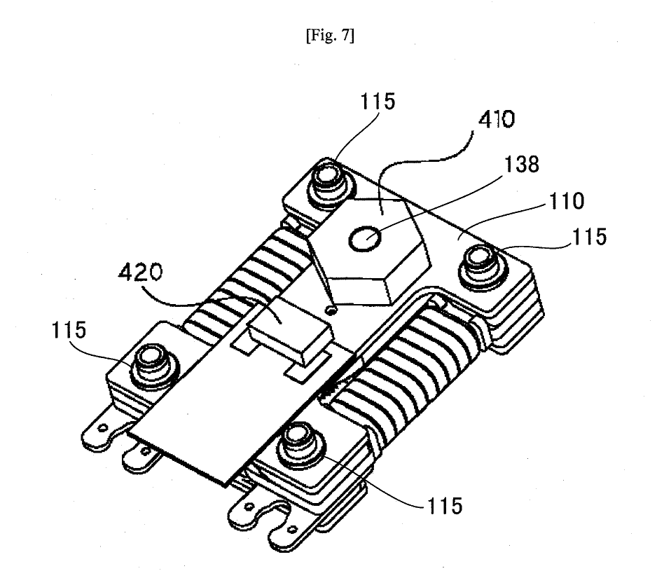

FIG. 7 shows an arrangement in which a hexagonal mirror 410 is fitted to the output gear shaft 138 of the electric motor apparatus 100 according to the first embodiment, and an LED (light-emitting diode) 420 is attached to the lower frame member 110 to emit light to the mirror 410. With this arrangement, the electric motor apparatus 100 may be used for illumination of a mobile phone or as a small emergency rotating light, for example.

Although some embodiments of the present invention have been described above, the present invention is not limited to the foregoing embodiments. The electric motor apparatus of the present invention can be used for performing various drive operations, e.g., for driving the diaphragm or spherical aberration correcting unit of a camera, in addition to the illustrated application examples. The electric motor apparatus of the present invention can incorporate a drive IC (drive integrated circuit; not shown), and thus can be used for a wide range of applications.

1. An electric motor apparatus comprising:
a rotor having a rotation axis, the rotor comprising a permanent magnet having two magnetic poles spaced from each other by substantially 180 degrees about the rotation axis;
a stator having a first magnetic pole portion, a second magnetic pole portion and a third magnetic pole portion successively disposed around the rotor, the first, second and third magnetic pole portions being spaced from each other in a circumferential direction about the rotation axis and respectively having magnetic pole surfaces disposed to face the rotor, the stator further having connecting portions each connecting between an associated pair of adjacent ones of the first, second and third magnetic pole portions around the rotor, the second magnetic pole portion extending radially outward with respect to the rotation axis from the magnetic pole surface of the second magnetic pole portion, the first and third magnetic pole portions extending radially outward with respect to the rotation axis and away from each other from their respective magnetic pole surfaces, the connecting portions each have a reduced cross-sectional area that is gradually reduced from the associated pair of adjacent magnetic pole portions toward a substantially central region between the associated pair of adjacent magnetic pole portions and each have a smallest cross-sectional area at the substantially central region between the associated pair of adjacent magnetic pole portions; and
first and second electromagnetic coils, the first electromagnetic coil inducing a magnetic circuit that passes through the first and second magnetic pole portions, the second electromagnetic coil inducing a magnetic circuit that passes through the second and third magnetic pole portions, the first and second electromagnetic coils being set parallel to and at opposite sides of the second magnetic pole portion, the first electromagnetic coil having one end coupled to the first magnetic pole portion and an other end magnetically coupled to the second magnetic pole portion, the second electromagnetic coil having one end magnetically coupled to the third magnetic pole portion and an other end magnetically coupled to the second magnetic pole portion, the first and second electromagnetic coils being selectively excited to control rotation of the rotor.

2. The electric motor apparatus of claim 1, wherein the stator has a pass-through hole for coaxially accommodating the rotor, the pass-through hole being defined by the magnetic pole surfaces of the first, second and third magnetic pole portions and respective inner surfaces of the connecting portions, and the stator has notches formed at the pass-through hole, at positions adjacent to the magnetic pole surfaces of the first and third magnetic pole portions, the notches extending substantially parallel to the rotation axis.

3. The electric motor apparatus of claim 2, further comprising a notch that extends substantially parallel to the rotation axis and is formed on a substantially central region of the magnetic pole surface of the second magnetic pole portion.

4. The electric motor apparatus of claim 2, further comprising two notches that extend parallel to the rotation axis and are formed at spaced positions in the magnetic pole surface of the second magnetic pole portion, the two notches spaced from each other with a substantially central region of the magnetic pole surface being interposed between the two notches.

5. The electric motor apparatus of claim 2, wherein the stator is a member flat in a direction of the rotation axis;
the electric motor apparatus further comprising:
flat first and second frame members that hold the stator between the first and second frame members from both sides in the direction of the rotation axis;
the first frame member having a pass-through hole aligned with the pass-through hole of the stator in the direction of the rotation axis and a rotor support member fitted in the pass-through hole;
the rotor being rotatably supported by the rotor support member.

6. The electric motor apparatus of claim 5, wherein the stator and the permanent magnet of the rotor have substantially a same thickness in the direction of the rotation axis.

7. The electric motor apparatus of claim 1, further comprising:
a speed reduction gear that outputs rotation of the rotor to an outside of the electric motor apparatus after reducing a speed of the rotation, the speed reduction gear having an output gear with an output shaft coaxially connected to the output gear and an intermediate gear with an intermediate shaft coaxially connected to the intermediate gear, the intermediate gear transmitting the rotation of the rotor to the output gear;
the second magnetic pole portion having pass-through holes through which the output shaft and the intermediate shaft are inserted, respectively.

8. The electric motor apparatus of claim 1, wherein the stator has extensions that extend in mutually opposite lateral directions from an extended end portion of the second magnetic pole portion, the extended end portion extending radially outward from the magnetic pole surface of the second magnetic pole portion, the stator thus having a substantially H-shape as a whole;
the first and second electromagnetic coils each comprising a flat plate-shaped magnetic member and a coil wire wound around the magnetic member, the flat plate-shaped magnetic members of the first and second electromagnetic coils having one end portions engaged and connected to the first and third magnetic pole portions, respectively, and other end portions engaged and connected to the corresponding extensions of the second magnetic pole portion, respectively.

9. The electric motor apparatus of claim 1, further comprising:
first and second frame members that are stacked to hold the stator and the first and second electromagnetic coils between the frame members from both sides in a direction of the rotation axis;
the stator having extensions that extend in mutually opposite lateral directions from an extended end portion of the second magnetic pole portion, the extended end portion that is extended radially outward from the magnetic pole surface of the second magnetic pole portion, the stator thus having a substantially H-shape as a whole;
the first and second electromagnetic coils each comprising a flat plate-shaped magnetic member and a coil wire wound around the magnetic member, the magnetic members of the first and second electromagnetic coils having one end portions that are connected to the first and third magnetic pole portions, respectively, and other end portions that are connected to respective end portions of the corresponding extensions of the second magnetic pole portion;
the stacked first and second frame members, the stator and the magnetic members of the first and second electromagnetic coils having pass-through holes in their portions superimposed in the direction of the rotation axis, the pass-through holes being aligned with each other in the direction of the rotation axis;
the electric motor apparatus further comprising;
fastening screws passed through the pass-through holes to connect and secure the first and second frame members, the stator and the first and second electromagnetic coils together.

10. The electric motor apparatus of claim 1, wherein the first, second and third magnetic pole portions of the stator, in combination, have a substantially T-shape.
